(19) United States
(12) Patent Application Publication
(10) Pub. No.: US 2017/0262993 A1
(43) Pub. Date: Sep. 14, 2017

(54) IMAGE PROCESSING DEVICE AND IMAGE PROCESSING METHOD

(71) Applicant: Kabushiki Kaisha Toshiba, Tokyo (JP)

(72) Inventors: Masato Uchiyama, Kawasaki Kanagawa (JP); Hyunjong Ji, Kawasaki Kanagawa (JP)

(21) Appl. No.: 15/270,255

(22) Filed: Sep. 20, 2016

Related U.S. Application Data
(60) Provisional application No. 62/305,979, filed on Mar. 9, 2016.

(51) Int. Cl. G06T 7/00; H04N 13/02; H04N 13/00

(52) U.S. Cl. CPC G06T 7/0069; G06T 7/0022; G06T 7/0077; H04N 13/0007; H04N 13/0271; H04N 13/0282; G06T 2207/10028; G06T 2207/10148; H04N 2013/0081

(57) ABSTRACT

According to one embodiment, an image processing device includes a synthesis processing unit. The synthesis processing unit synthesizes a plurality of depth maps. A depth map is generated based on images that are mutually different in viewpoint. The plurality of depth maps are mutually different in focal length. The depth map includes distance data in a distance range set in accordance with the focal length.

### CROSS-REFERENCE TO RELATED APPLICATIONS

This application is based upon and claims the benefit of priority from U.S. Provisional Application No. 62/305,979, filed on Mar. 9, 2016; the entire contents of which are incorporated herein by reference.

### FIELD

Embodiments described herein relate generally to an image processing device and an image processing method.

### BACKGROUND

Conventionally, there is a known technique of generating a depth map based on images formed in mutually different viewpoints. The depth map is an image having data of a distance from a viewpoint to a subject. In this technique, it is desired that a depth map with high accuracy can be generated by using captured images.

### BRIEF DESCRIPTION OF THE DRAWINGS

FIG. 1 is a block diagram of a system including an image processing device according to a first embodiment;

FIG. 2 is an explanatory diagram of a focal length set by a focal-length setting unit illustrated in FIG. 1 and an effective distance range;

FIG. 3 is a flowchart illustrating a procedure of an image processing method according to the first embodiment;

FIG. 4 is a block diagram illustrating a hardware configuration of the image processing device illustrated in FIG. 1;

FIG. 5 is a block diagram of a system including an image processing device according to a second embodiment;

FIG. 6 is an explanatory diagram of weight coefficients for generation of weight data in a weighting processing unit and a focal length; and

FIG. 7 is a flowchart illustrating a procedure of an image processing method according to the second embodiment.

### DETAILED DESCRIPTION

In general, according to one embodiment, an image processing device includes a synthesis processing unit. The synthesis processing unit synthesizes a plurality of depth maps. A depth map is generated based on images that are mutually different in viewpoint. The plurality of depth maps are mutually different in focal length. The depth map includes distance data in a distance range set in accordance with the focal length.

Exemplary embodiments of an image processing device and an image processing method will be explained below in detail with reference to the accompanying drawings. The present invention is not limited to the following embodiments.

### First Embodiment

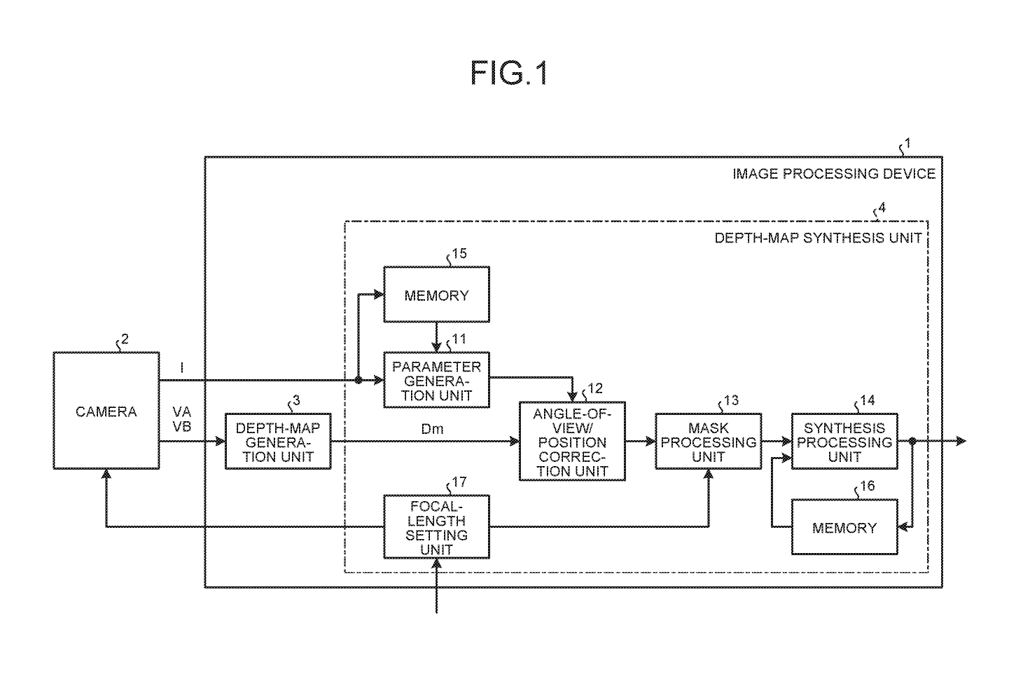

FIG. 1 is a block diagram of a system including an image processing device according to a first embodiment. An image processing device 1 generates a depth map by using images captured by a camera 2.

The camera 2 includes an imaging optical system, an image sensor, an image signal processing circuit, and a lens actuator (all not illustrated). The imaging optical system takes in light from a subject to cause a subject image to be formed. The image sensor images the subject image. The image signal processing circuit processes an image signal from the image sensor. The lens actuator moves a lens included in the imaging optical system in an optical-axis direction.

The camera 2 simultaneously captures a normal image I and two viewpoint images VA and VB of which viewpoints are mutually different. The camera 2 captures the viewpoint images VA and VB by using a plurality of phase-difference pixels provided in the image sensor. Each phase-difference pixel is provided with an opening allowing light to pass therethrough and a light-shielding portion shielding portions other than the opening. The camera 2 obtains the two viewpoint images VA and VB by using each of two kinds of phase-difference pixels that are mutually different in position of the opening. A part of a plurality of pixels arranged in an effective pixel region of the image sensor is designated as the phase-difference pixels, and pixels other than the phase-difference pixels are used for capturing the normal image I.

The image processing device 1 is hardware in which a program for implementing an image processing method according to the present embodiment is installed. The functions provided in the program are realized by using a computer that is hardware. The image processing device 1 includes a depth-map generation unit 3 and a depth-map synthesis unit 4 that are functional units implemented by using a hardware configuration.

The normal image I and the two viewpoint images VA and VB are input to the image processing device 1. The depth-map generation unit 3 generates a depth map Dm based on the viewpoint images VA and VB by stereo matching processing, for example. The depth-map generation unit 3 generates the depth map Dm in which values indicating distances (such as z-values described later) are mapped two-dimensionally (x-y). A group of values indicating distances are referred to as “distance data”.

The lens actuator includes a closed-loop VCM (voice coil motor) that executes feedback control of a position of the lens. For example, the image signal processing circuit of the camera 2 or the depth-map generation unit 3 refers to a table preset based on the driving current value of the VCM to convert a disparity to a z-value. In the table, driving current values of the VCM and focal lengths of the lens when the VCM is driven by the respective current values are corresponded to each other and stored. Either of the image processing device 1 and the camera 2 may hold the table.

The depth-map synthesis unit 4 sets a focal length of the camera 2 in accordance with information input to the image processing device 1. While sequentially adjusting the focus of the lens in accordance with the set focal length, the camera 2 captures the normal image I and the viewpoint images VA and VB. The depth-map synthesis unit 4 synthesizes a plurality of depth maps Dm obtained from the viewpoint images VA and VB captured every time the focus is adjusted to generate a synthesized depth map.

The depth-map synthesis unit 4 includes a parameter generation unit 11, an angle-of-view/position correction unit 12, a mask processing unit 13, a synthesis processing unit 14, memories 15 and 16, and a focal-length setting unit 17.

The memory 15 holds the normal image I used for correction of the depth map Dm as a reference image. The normal image I from the camera 2 or the reference image from the memory 15 is input to the parameter generation unit 11.

For example, the parameter generation unit 11 calculates an affine parameter for geometrically transforming the normal image I based on a reference image or a correction parameter for each pixel. The parameter generation unit 11 calculates these parameters based on a result of a search of corresponding points in the normal image I with respect to the reference image by a block matching method.

The angle-of-view/position correction unit 12 corrects an angle of view and a position of the depth map Dm based on a parameter from the parameter generation unit 11. Changing the focal length changes a range of a space (an angle of view) that is an object of which distance data is taken in to the depth map Dm. By correcting the angle of view, the angle-of-view/position correction unit 12 brings the ranges of the respective depth maps Dm into coincidence with each other. Further, the angle-of-view/position correction unit 12 corrects misalignment between the depth maps Dm.

The focal-length setting unit 17 sets a focal length based on information input to the image processing device 1. The lens actuator of the camera 2 moves a lens to bring the focus on a position of the set focal length. The focal-length setting unit 17 outputs information on the focal length and information on an effective distance range corresponding to the focal length to the mask processing unit 13.

The mask processing unit 13 performs a mask process that removes distance data outside the effective distance range in the distance data included in the depth map Dm. That is, the mask processing unit 13 extracts distance data on a subject in the effective distance range from the depth map Dm.

The synthesis processing unit 14 synthesizes a plurality of depth maps Dm that have undergone a mask process so as to generate a synthesized depth map. The synthesis processing unit 14 adds the distance data extracted from the plurality of depth maps Dm obtained by changing the focal length. The memory 16 holds the synthesized depth map.

The depth-map synthesis unit 4 outputs a synthesized depth map that is a final synthesis result. The image processing device 1 generates the synthesized depth map from images captured in real time by the camera 2. It is also possible that the image processing device 1 generates the synthesized depth map by reading images captured in the past by the camera 2 from a memory or the like.

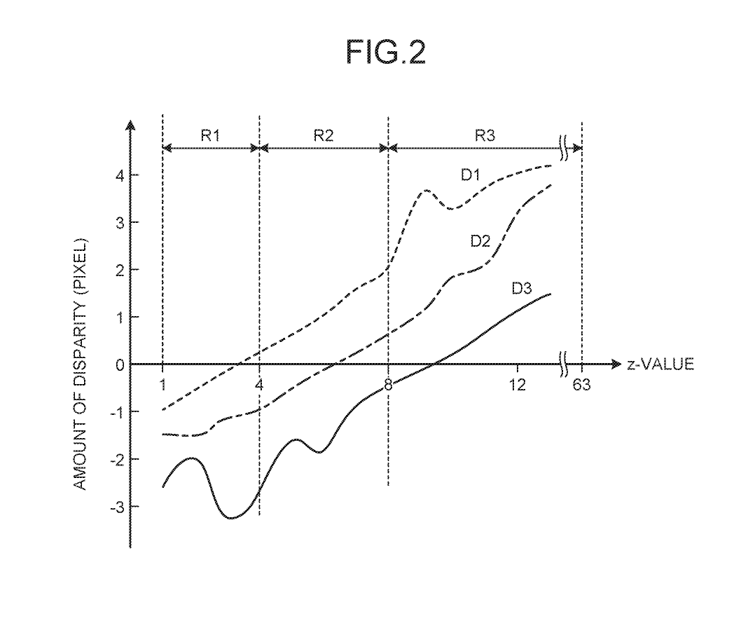

FIG. 2 is an explanatory diagram of a focal length set by the focal-length setting unit 17 and an effective distance range. The vertical axis in the graph represents an amount of disparity using a pixel as its unit, and the horizontal axis represents a z-value in a case where a distance is represented as 120/z (cm). Note that z=0 represents that there is no information indicating the distance.

The graph of FIG. 2 illustrates examples of a relation between the amount of disparity observed in a state where a focus is placed on a certain position and an actual distance. FIG. 2 illustrates respective relations when a focal length is D1=40 cm (z=3), D2=20 cm (z=6), and D3=12 cm (z=10).

In any of the relations for D1, D2, and D3, a stable linear relation is kept between the actual distance and the amount of disparity in a range close to the focus. In this range, it is possible to obtain highly reliable distance data by using a linear approximation. On the other hand, a stable linear relation is not kept in a range farther from the focus and the accuracy of distance measurement is lowered.

In the depth-map synthesis unit 4, a distance range within which the actual distance and the amount of disparity have a stable linear relation therebetween is set as the effective distance range. The effective distance range is set for each focal length. For example, in the relations illustrated in FIG. 2, an effective distance range R1 for D1 is set to a range from z=1 to z=4, an effective distance range R2 for D2 is set to a range from z=4 to z=8, and an effective distance range R3 for D3 is set to a range from z=8 to z=63. The effective distance range is determined in advance based on a result of prior evaluation of the camera 2 and the depth-map generation unit 3.

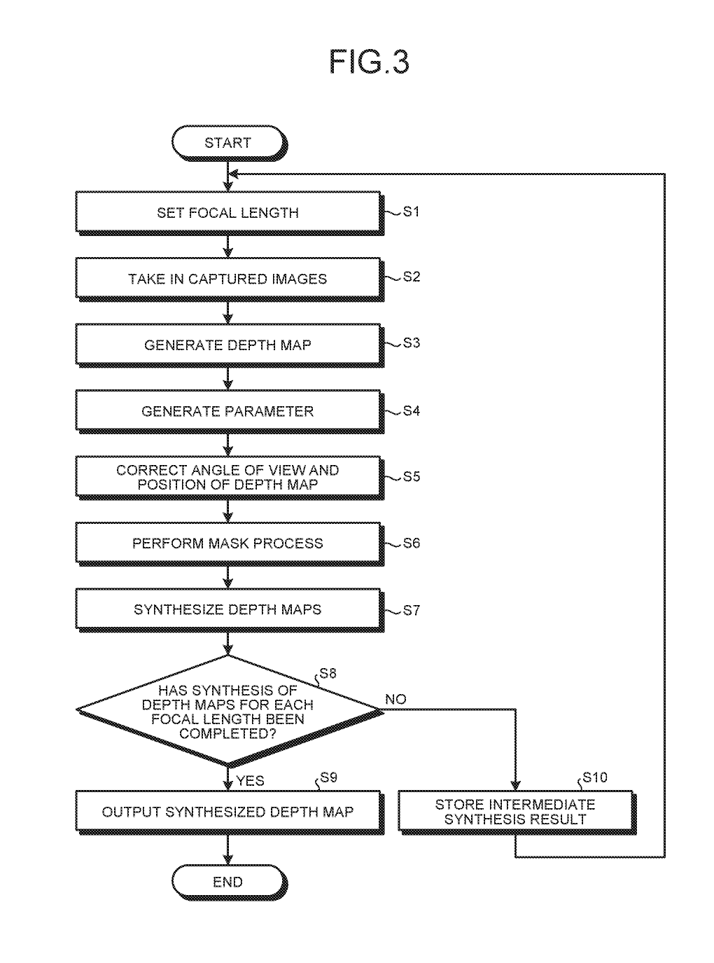

FIG. 3 is a flowchart illustrating a procedure of the image processing method according to the first embodiment. The depth-map synthesis unit 4 synthesizes N depth maps Dm1, . . . , DmN that are generated for focal lengths D1, . . . , DN so as to generate a synthesized depth map. As for the generation of one synthesized depth map, the camera 2 performs image capturing N times. N is an arbitrary integer equal to or larger than 2.

Information related to setting of the camera 2 and setting in synthesis of depth maps, for example, information related to the number of times of image capturing, focal lengths, and effective distance ranges is input to the image processing device 1.

A case where three (N=3) depth maps Dm1, Dm2, and Dm3 are synthesized is described here as an example. Values of focal lengths D1, D2, and D3 (that are assumed to be 40 cm, 20 cm, and 12 cm, respectively) and values indicating effective distance ranges R1, R2, and R3 corresponding to the respective focal lengths D are input to the image processing device 1. The input focal lengths may be z-values.

As the values indicating R1, R2, and R3, a minimum value and a maximum value of the z-value are input, for example. As for R1 (z=1 to 4), a minimum value Rmin1=1 and a maximum value Rmax1=4 are input, for example.

Instead of the value indicating the focal length itself, for example, a value indicating a gap between the foci may be input to the image processing device 1. The focal-length setting unit 17 determines each focal length by using the value indicating the gap. The focal-length setting unit 17 uses a value indicating a gap between D2 and D1 and a value indicating a gap between D3 and D2 to determine D1, D2, and D3.

The focal-length setting unit 17 sets the focal lengths based on information input to the image processing device 1 (S1). In initial setting, the focal-length setting unit 17 sets the shortest focal length (D3). The focal-length setting unit 17 outputs the value D3 to the camera 2 and outputs the respective values D3 and R3 (Rmin3=8 and Rmax3=63) to the mask processing unit 13.

The lens actuator of the camera 2 moves the lens to bring the focus on a position of the set focal length. The camera 2 captures the normal image I and viewpoint images VA and VB. The camera 2 uses the value D3 as the focal length in the first image capturing. The image processing device 1 takes in the captured normal image I and the viewpoint images VA and VB that are first images (S2).

The depth-map generation unit 3 generates a depth map based on the viewpoint images VA and VB (S3). The depth-map generation unit 3 generates a depth map in which z-values are mapped. The depth-map generation unit 3 generates the depth map Dm3 for the focal length D3 (first depth map) by the first image capturing.

The memory 15 holds a reference image that is used as a reference of correction in the angle-of-view/position correction unit 12. The reference image is the normal image I captured first, and is the normal image I with the focal length D3 in this example.

The parameter generation unit 11 generates a parameter for correction of an angle of view and a position of the depth map based on the normal image I input from the camera 2 and the reference image (S4). The angle-of-view/position correction unit 12 uses the generated parameter to correct the angle of view and the position of the depth map (S5). Note that correction of the angle of view and the position is skipped for the depth map Dm3 generated first.

The mask processing unit 13 performs a mask process that removes distance data outside an effective distance range from distance data included in the depth map (S6). As for the depth map Dm3, the mask processing unit 13 masks values out of the range R3, that is, z-values that satisfy z≦8 or 63≦z. The mask processing unit 13 deletes information indicating a distance, for example, by rewriting all the z-values outside the effective distance range to 0. Note that a first distance range R3 includes a first focus (z=10) in the first image capturing.

The synthesis processing unit 14 synthesizes depth maps that have undergone the mask process (S7). In the initial setting, the synthesis processing unit 14 sets all z-values in a synthesized depth map held in the memory 16 to 0. The synthesis processing unit 14 adds distance data of the depth map Dm3 to a map placed in an initial state to generate a synthesized depth map DmF₃.

The synthesis processing unit 14 determines whether synthesis of the depth maps for all the focal lengths has been completed (S8). At a time point when the depth map Dm3 has been synthesized, synthesis for D2 and D1 has not been completed yet (NO at S8). The synthesis processing unit 14 stores the depth map DmF₃, which is an intermediate synthesis result in the memory 16 (S10).

Subsequently, the focal length is set to D2 and the procedure from S1 is repeated. The focal-length setting unit 17 outputs the value of D2 to the camera 2 and outputs the respective values of D2 and R2 (Rmin2=4 and Rmax2=8) to the mask processing unit 13. The camera 2 performs image capturing for the focal length D2 as second image capturing. The image processing device 1 takes in the normal image I with the focal length D2 and viewpoint images VA and VB that are second images (S2). The depth-map generation unit 3 generates the depth map Dm2 for the focal length D2 (second depth map) (S3).

The parameter generation unit 11 generates a parameter for correction of the angle of view and the position of the depth map Dm2 based on the normal image I with the focal length D2 and the reference image (S4). The angle-of-view/position correction unit 12 uses the generated parameter to correct the angle of view and the position of the depth map Dm2 (S5).

The mask processing unit 13 performs the mask process for the depth map Dm2 (S6). As for the depth map Dm2, the mask processing unit 13 masks values out of R2, that is, z-values that satisfy z≦4 or 8≧z. Note that a second distance range R2 includes a second focus (z=6) in the second image capturing.

The synthesis processing unit 14 synthesizes the synthesized depth map DmF₃ held in the memory 16 and the depth map Dm2 that has undergone the mask process (S7). The synthesis processing unit 14 adds distance data of the depth maps Dm2 to DmF₃ to generate a synthesized depth map DmF₂₊₃. At a time point when the depth maps Dm2 and DmF₃ have been synthesized, synthesis for D1 has not been completed yet (NO at S8). The synthesis processing unit 14 stores DmF₂₊₃ that is an intermediate synthesis result in the memory 16 (S10).

Subsequently, S1 to S6 are performed as processes for the focal length D1 in a similar manner. At S6, the mask processing unit 13 masks values out of R1 for the depth map Dm1, that is, z-values that satisfy z≦1 or 4≧z. Note that a third distance range R1 includes a third focus (z=3) in the third image capturing.

The synthesis processing unit 14 synthesizes the synthesized depth map DmF₂₊₃ held in the memory 16 and the depth map Dm1 that has undergone the mask process (S7). The synthesis processing unit 14 adds distance data of the depth map Dm1 to that of DmF₂₊₃ to generate a synthesized depth map DmF₁₊₂₊₃. Because synthesis of all the depth maps has been completed (YES at S8), the synthesis processing unit 14 outputs DmF₁₊₂₊₃ that is a final synthesis result (S9). Due to this operation, the image processing device 1 ends the process for synthesizing the depth maps.

The depth-map synthesis unit 4 is not limited to a unit that generates the synthesized depth map DmF_{1+ . . . +N} by synthesizing the three depth maps Dm1, Dm2, and Dm3. The number of the depth maps synthesized in generation of the depth map DmF_{1+ . . . +N} may be changed as appropriate. The number of the depth maps may be a number that allows respective ranges of closer distances, intermediate distances, and farther distances to be covered by the effective distance range set for each focal length, and may be 3 or a number close to 3. The image processing device 1 can reduce the number of the depth maps to be generated and processed for obtaining one synthesized depth map to a relatively small number, and therefore enables a highly accurate synthesized depth map to be obtained with a less process load.

The depth-map synthesis unit 4 is not limited to a unit that synthesizes a depth map every time the depth map has been generated. It is also possible that the depth-map synthesis unit 4 synthesizes depth maps all at once after all the depth maps have been generated.

The depth-map synthesis unit 4 may omit correction of the angle of view and the position of the depth map. The depth-map synthesis unit 4 may not include the parameter generation unit 11 and the angle-of-view/position correction unit 12.

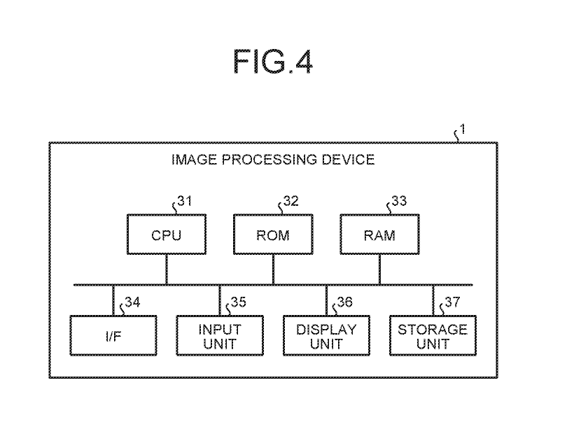

FIG. 4 is a block diagram illustrating a hardware configuration of the image processing device 1. Programs installed in a computer that is the image processing device 1 include respective programs for generation and synthesis of depth maps. The function of the depth-map generation unit 3 is implemented by the depth-map generation program. The function of the depth-map synthesis unit 4 is implemented by the depth-map synthesis program.

The image processing device 1 includes a CPU (Central Processing Unit) 31, a ROM (Read Only Memory) 32, a RAM (Random Access Memory) 33, an interface (I/F) 34, an input unit 35, a display unit 36, and a storage unit 37, and a bus connecting these elements to each other in a communicable manner.

The programs for generation and synthesis of the depth maps are stored in the ROM 32 and are loaded to the RAM 33 via the bus. The CPU 31 develops the programs in a program storage region in the RAM 33 and performs various kinds of processes. A data storage region in the RAM 33 is used as a work memory when the various kinds of processes are performed.

The I/F 34 is an interface for connection with the camera 2. The input unit 35 is, for example, a keyboard or a pointing device that receives an input operation to the image processing device 1. The input unit 35 receives input of information related to a setting condition. The display unit 36 is a liquid crystal display, for example. The storage unit 37 that is an external storage device stores therein a synthesized depth map that is a final synthesis result.

Generation and synthesis of the depth maps can be also achieved by an electronic device other than the computer. The image processing device 1 may be any electronic device other than the computer. The image processing device 1 may be a portable device in which an application for achieving the image processing method according to the present embodiment is installed or a dedicated chip that can execute a program, for example.

According to the first embodiment, the image processing device 1 synthesizes a plurality of depth maps including distance data in distance ranges respectively corresponding to focal lengths. The image processing device 1 can obtain a highly accurate depth map by synthesizing the depth maps including highly reliable distance data. Due to this configuration, the image processing device 1 can obtain a highly accurate depth map by using captured images.

### Second Embodiment

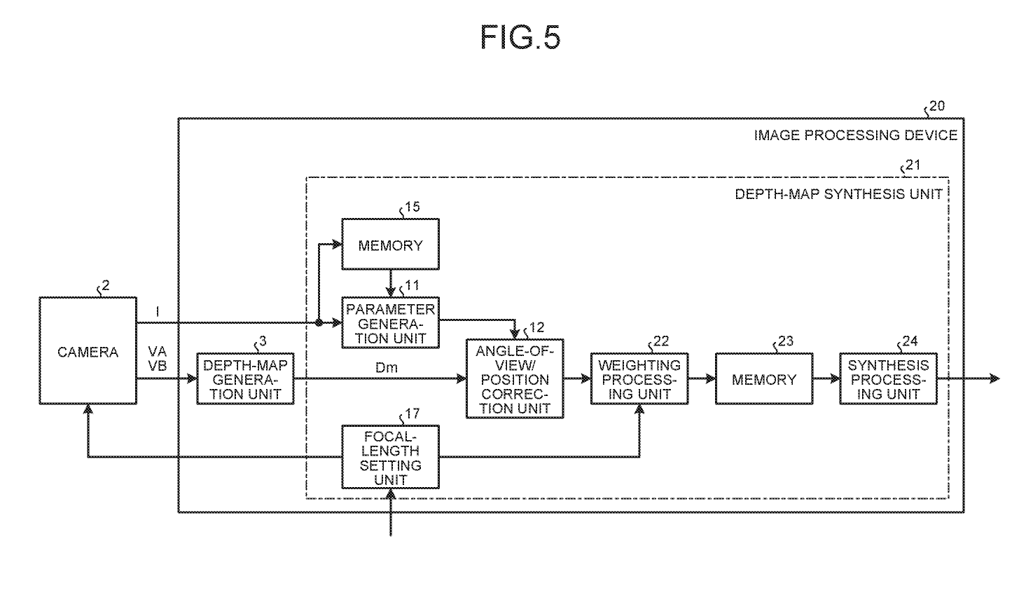

FIG. 5 is a block diagram of a system including an image processing device according to a second embodiment. Elements identical to those of the first embodiment are denoted by like reference signs and redundant descriptions thereof will be omitted.

An image processing device 20 includes the depth-map generation unit 3 and a depth-map synthesis unit 21. The depth-map synthesis unit 21 includes the parameter generation unit 11, the angle-of-view/position correction unit 12, the memory 15 and a memory 23, the focal-length setting unit 17, a weighting processing unit 22, and a synthesis processing unit 24.

The weighting processing unit 22 generates weight data for distance data included in a depth map Dm. The weighting processing unit 22 obtains a weight coefficient corresponding to a distance from a focus, and generates the weight data that is a group of the weight coefficients corresponding to the depth map Dm. The weighting processing unit 22 generates the weight data corresponding to the distances from the focus for each focal length set in the focal-length setting unit 17.

The memory 23 includes a region in which the depth map Dm is stored and a region in which the weight data is stored. The synthesis processing unit 24 performs, for every depth map Dm, weighting with the weighting data, and adds the distance data of a plurality of depth maps Dm to one another. The synthesis processing unit 24 generates a synthesized depth map by synthesis of the plural weighted depth maps Dm.

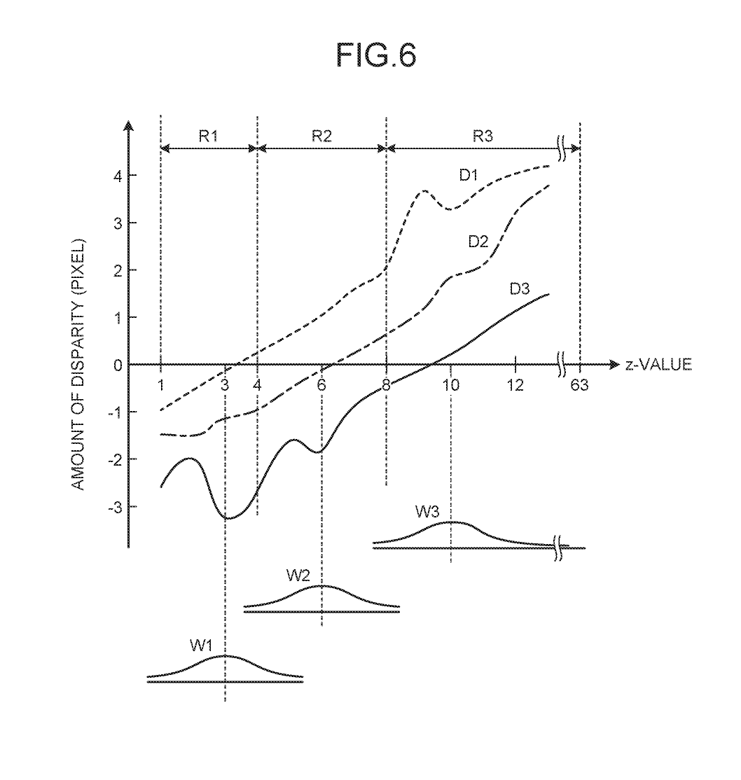

FIG. 6 is an explanatory diagram of weight coefficients for generation of weight data in the weighting processing unit 22 and a focal length. Weight coefficients W1 for the depth map Dm1 for a focal length D1 are set to be smaller as a distance from z=3 (a third focus) increases in an effective distance range R1. W1 has a normal distribution centered on z=3, for example.

Weight coefficients W2 and W3 for focal lengths D2 and D3 are also set in a similar manner to W1. W2 has a normal distribution centered on z=6 (a second focus), for example. W3 has a normal distribution centered on z=10 (a first focus), for example. In view of the fact that a stable linear relation between an actual distance and the amount of disparity is kept in a range close to the focus, W1, W2, and W3 are set in such a manner that a weight is larger at a closer position to the focus at which highly reliable distance data is obtained.

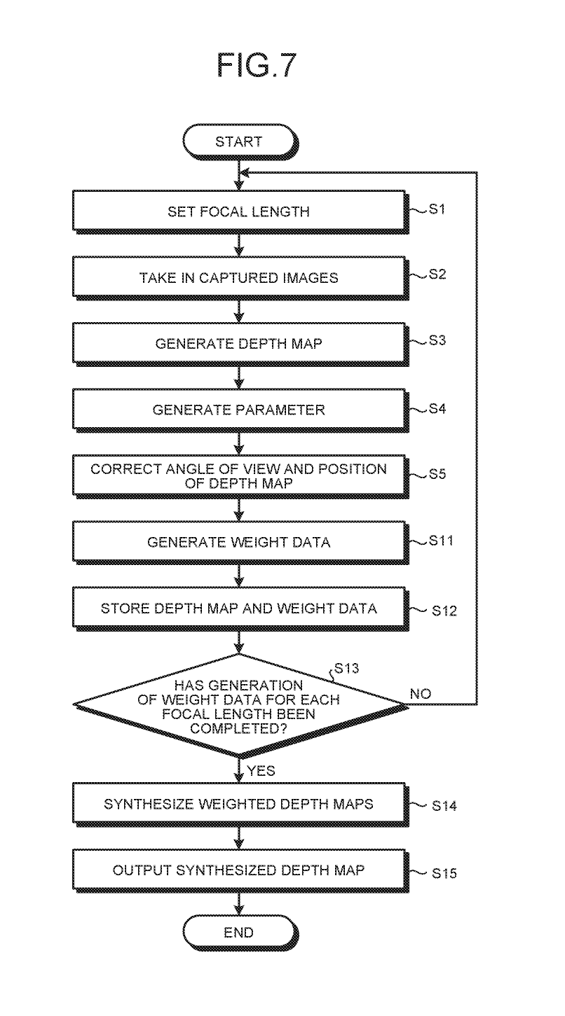

FIG. 7 is a flowchart illustrating a procedure of an image processing method according to the second embodiment. Steps S1 to S5 are the same as those in the first embodiment.

The weighting processing unit 22 generates weight data in which weight coefficients corresponding to distance information mapped in a depth map are grouped (S11). The weighting processing unit 22 determines the weight coefficient for each z-value in accordance with a distribution of the weight coefficients centered on a focus. A function representing the distribution of the weight coefficients, for example, is preset in the weighting processing unit 22. The weighting processing unit 22 uses the weight coefficients W1, W2, and W3 obtained based on the function and each focal length. The memory 23 stores therein the depth map and the weight data (S12).

The weighting processing unit 22 determines whether generation of the weight data for each focal length has been completed (S13). At a time point when first weight data for a first generated depth map Dm3 has been generated, generation of second weight data for D2 and third weight data for D1 have not completed yet (NO at S13). Thereafter, the focal lengths are set to D2 and D1, and the procedure from S1 is repeated.

When generation of the weight data for each depth map has been completed (YES at S13), the synthesis processing unit 24 synthesizes all the depth maps that have been weighted in accordance with the respective weight data (S14). The synthesis processing unit 24 multiplies the depth maps by the weight coefficients W1, W2, and W3 that correspond to the mapped z-values, respectively, and adds all multiplication results.

The synthesis processing unit 24 generates a synthesized depth map DmF₁₊₂₊₃ that is a final synthesis result by this synthesis of the depth maps, and outputs the synthesized depth map DmF₁₊₂₊₃ (S15). Due to this configuration, the image processing device 20 ends the process for synthesizing the depth maps.

According to the second embodiment, the image processing device 20 performs weighting in accordance with a distance from a focus, for distance data of a depth map. The image processing device 20 synthesizes depth maps including the distance data weighted in accordance with the level of reliability. In this manner, the image processing device 20 can obtain a highly accurate depth map by using captured images.

### Third Embodiment

An image processing device according to a third embodiment includes the same configuration as the image processing device 1 according to the first embodiment. Descriptions of the third embodiment redundant to those of the first embodiment will be omitted.

In a case where a plurality of depth maps having undergone a mask process have been synthesized, a portion of which distance information remains blank can be generated in a synthesized depth map. In the third embodiment, the depth-map synthesis unit 4 fills information of a depth map before having undergone the mask process into the blank portion of the synthesized depth map.

A procedure of an image processing method according to the third embodiment is described with reference to FIG. 3. In this example, the depth-map synthesis unit 4 uses distance data of the depth map Dm2 for D2 that corresponds to an intermediate distance, for filling a blank.

The depth-map synthesis unit 4 processes the depth map Dm3 generated first, in the same procedure as that in the first embodiment. The synthesis processing unit 14 adds distance data in an effective distance region R3 to a map placed in an initial state so as to generate a synthesized depth map DmF₃.

As for the depth map Dm2, the depth-map synthesis unit 4 skips the mask process at S6 and a synthesis process at S7. The depth-map synthesis unit 4 temporarily holds the depth map Dm2 that has been subjected to correction at S5. The depth-map synthesis unit 4 processes the depth map Dm1 in the same procedure as that in the first embodiment.

The synthesis processing unit 14 synthesizes the depth map Dm1 and the synthesized depth map DmF₃ to generate a synthesized depth map DmF₁₊₃. A portion that is blank (z=0) in both Dm3 and Dm1 is a blank portion of the synthesized depth map DmF₁₊₃.

The synthesis processing unit 14 synthesizes the held depth map Dm2 to a blank portion of the synthesized depth map DmF₁₊₃ to generate a synthesized depth map DmF₁₊₂₊₃ that is a final synthesis result. Distance data of Dm2 is overwritten to the blank portion of the synthesized depth map DmF₁₊₃.

In this manner, the synthesis processing unit 14 overwrites the distance data of Dm2 before having undergone the mask process to the blank portion of the synthesized depth map DmF₁+₃ into which Dm3 and Dm1 having undergone the mask process have been synthesized. Due to this operation, the depth-map synthesis unit 4 fills information from one depth map Dm2 into a portion that remains blank in synthesis of depth maps having undergone the mask process.

The depth-map synthesis unit 4 may fill information of any depth map into the blank portion, instead of the depth map Dm2. The depth-map synthesis unit 4 may fill information based on two or more depth maps, instead of information of one depth map only. The depth-map synthesis unit 4 may overwrite an average value of z-values in a plurality of depth maps to the blank portion, for example.

According to the third embodiment, a portion that is blank in synthesis of depth maps having undergone a mask process is filled with information of a depth map. Due to this configuration, it is possible to obtain a synthesized depth map in which a blank of distance information is eliminated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising a synthesis processing unit configured to synthesize a plurality of depth maps that are mutually different in focal length, a depth map being generated based on images that are mutually different in viewpoint and including distance data in a distance range set in accordance with the focal length.

2. The image processing device according to claim 1, further comprising a mask processing unit configured to mask distance data outside the distance range in the depth map, wherein
the synthesis processing unit synthesizes the depth maps having undergone a mask process.

3. The image processing device according to claim 1, further comprising a weighting processing unit configured to generate weight data for the distance data, wherein
the synthesis processing unit synthesizes the depth maps weighted based on the weight data.

4. The image processing device according to claim 2, further comprising a focal-length setting unit configured to set the focal length, wherein
the mask processing unit performs the mask process based on a distance range corresponding to a set focal length.

5. The image processing device according to claim 3, further comprising a focal-length setting unit configured to set the focal length, wherein
the weighting processing unit generates weight data in accordance with a distance from a focus with respect to set focal length.

6. The image processing device according to claim 1, further comprising a mask processing unit configured to mask distance data outside the distance range from the depth map, wherein
the synthesis processing unit overwrites distance data of a depth map before having undergone a mask process to a blank portion of a synthesized depth map into which depth maps having undergone a mask process have been synthesized.

7. The image processing device according to claim 1, further comprising a correction unit configured to correct an angle of view of the depth map.

8. An image processing device comprising a synthesis processing unit configured to synthesize a first depth map based on first images and a second depth map based on second images, the first depth map including distance data in a first distance range which includes a first focus in capturing the first images, the second depth map including distance data in a second distance range which includes a second focus in capturing the second images.

9. The image processing device according to claim 8, further comprising a mask processing unit configured to mask distance data outside the first distance range in the first depth map and mask distance data outside the second distance range in the second depth map, wherein
the synthesis processing unit synthesizes a first depth map and a second depth map that have undergone a mask process.

10. The image processing device according to claim 8, further comprising a weighting processing unit configured to generate first weight data for distance data included in the first depth map and second weight data for distance data included in the second depth map, wherein
the synthesis processing unit synthesizes a first depth map weighted based on the first weighting data and a second depth map weighted based on the second weight data.

11. The image processing device according to claim 8, further comprising a focal-length setting unit configured to set a first focal length in capturing the first images and a second focal length in capturing the second images.

12. The image processing device according to claim 10, wherein the weighting processing unit generates the first weight data corresponding to a distance from the first focus and generates the second weight data corresponding to a distance from the second focus.

13. The image processing device according to claim 8, further comprising a mask processing unit configured to mask distance data outside the first distance range in the first depth map, wherein
the synthesis processing unit overwrites distance data of the second depth map before having undergone a mask process, to a blank portion of a synthesized depth map into which the first depth map having undergone a mask process has been synthesized.

14. The image processing device according to claim 8, further comprising a correction unit configured to correct an angle of view of the second depth map based on a reference image captured together with the first images that are mutually different in viewpoint.

15. An image processing method comprising:
taking in a depth map generated based on images that are mutually different in viewpoint; and
synthesizing a plurality of depth maps that are mutually different in focal length in capturing the images, the depth map including distance data in a distance range set in accordance with the focal length.

16. The image processing method according to claim 15, further comprising:
masking distance data outside the distance range in the depth map; and
synthesizing the depth maps having undergone a mask process.

17. The image processing method according to claim 15, further comprising:
generating weight data for the distance data; and
synthesizing the depth maps weighted based on the weight data.

18. The image processing method according to claim 16, further comprising:
setting the focal length; and
performing a mask process based on a distance range corresponding to the focal length.

19. The image processing method according to claim 17, further comprising:
setting the focal length; and
generating weight data corresponding to a distance from a focus with respect to the focal length.

20. The image processing method according to claim 15, wherein the plurality of depth maps include a first depth map based on first images and a second depth map based on second images, the first depth map includes distance data in a first distance range that includes a first focus in capturing the first images, and the second depth map includes distance data in a second distance range that includes a second focus in capturing the second images.
